(19) United States
(12) Patent Application Publication
(10) Pub. No.: US 2006/0109583 A1
(43) Pub. Date: May 25, 2006

(54) Method and apparatus for servo writing with servo pattern examination in a disk drive

(75) Inventors: Hideo Sado, Ome-shi (JP); Masahide Yatsu, Akishima-shi (JP); Masafumi Iwashiro, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/253,643

(22) Filed: Oct. 20, 2005

(30) Foreign Application Priority Data
Nov. 24, 2004 (JP) 2004-339071

(51) Int. Cl. G11B 21/02; G11B 27/36

(52) U.S. Cl. 360/75; 360/31

(57) ABSTRACT

There is disclosed a servo information writing apparatus comprising a disk drive and an examination unit. The examination unit executes examination to select an adequate servo pattern as servo information from a plurality of types of servo patterns recorded beforehand in a disk medium incorporated in the disk drive. The selection unit executes an examination to select the adequate servo pattern by use of a control and signal processing system incorporated in the disk drive.

### CROSS-REFERENCE TO RELATED APPLICATIONS

This application is based upon and claims the benefit of priority from prior Japanese Patent Application No. 2004-339071, filed Nov. 24, 2004, the entire contents of which are incorporated herein by reference.

### BACKGROUND OF THE INVENTION

1. Field of the Invention

The present invention relates generally to a servo writer which writes servo information of a disk drive, and more particularly, it relates to a servo writer having a servo pattern examining function.

2. Description of the Related Art

In general, in the field of disk drives represented by hard disk drives, manufacturing steps include a servo writing step for recording servo information (servo data) on a disk medium which records data. The servo information means a servo pattern for use in a head positioning control to position a head at a target position (target track or target cylinder which is an access object) on the disk medium.

Since the servo writing step is a step requiring time for recording a high-precision servo pattern on the disk medium, various types of improvements or proposals have heretofore been performed in order to enhance efficiency.

In recent years, there has been noticed as an effective method a self-servowriting method in which the servo pattern is written with respect to the disk medium incorporated in the disk drive by means of the disk drive itself, or a magnetic transferring method

As a method of writing a high-precision servo pattern in which defects are further reduced by use of these writing methods, there is proposed a method in which a plurality of servo patterns are written beforehand on the disk medium, and an adequate servo pattern having less defects is selected as servo information from the servo patterns (see, e.g., Jpn. Pat. Appln. KOKAI Publication Nos. 9-134576 and 11-224474).

In the method described in the above-described related art documents, the plurality of servo patterns are written, and a servo pattern having a satisfactory written state is selected from the servo patterns.

Additionally, the precision of the servo pattern is also influenced by the disk medium incorporated in the disk drive, or a state of a component such as the head. Especially on the disk drive having a high recording density, in a case where the servo patterns are written, it is requested to consider a track pitch related to properties of the head, eccentricity related to an assembly precision (axial deviation amount) of the disk medium and the like.

### BRIEF SUMMARY OF THE INVENTION

In accordance with an aspect of the present invention, there is provided a servo writer in which an adequate servo pattern can be selected from a plurality of types of servo patterns to thereby write high-precision servo information.

The present servo writer has: an examination unit which executes examination processing to select an adequate servo pattern from a plurality of types of servo patterns recorded on a disk medium incorporated in a disk drive; and a selection unit which selects as servo information of the disk drive the servo pattern judged to be adequate by the examination unit.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an explanatory view of a constitution of a servo writer according to an embodiment of the present invention;

FIGS. 2A to 2C are explanatory views of a step of writing servo information according to the present embodiment;

FIG. 3 is a flowchart of a procedure of a method of writing the servo information according to the present embodiment;

FIGS. 4A and 4B are explanatory views of a recorded state of a servo pattern according to another embodiment; and

FIG. 5 is a flowchart of a procedure of the method of writing the servo information according to the other embodiment.

### DETAILED DESCRIPTION OF THE INVENTION

Embodiments of the present invention will be described hereinafter with reference to the drawings.

### Servo Information Writing Device

FIG. 1 is a block diagram showing a constitution of a servo information writing device according to the present embodiment.

The present device includes a disk drive 1 and an examination unit 10, and sets as servo information a servo pattern to be actually used from a plurality of types of servo patterns recorded on a disk medium 2 incorporated in the disk drive 1.

That is, in the present device, as described later, the examination unit 10 examines a plurality of types of servo patterns 100 recorded beforehand on the disk medium 2. The device selects an adequate (relatively adequate) servo pattern based on the examination result, and sets the pattern as the servo information.

The disk drive 1 is a drive finally formed into a product, and a drive mechanism including the disk medium 2 and a head 4, and a control and signal processing system for recording and reproducing data are incorporated at an assembling step before a step of writing the servo information.

The drive mechanism includes a spindle motor 3 which holds and rotates the disk medium 2, and an actuator 5 which holds the head 4 to move the head in a radial direction of the disk medium 2. The actuator 5 is constituted in such a manner that an arm holding the head 4 moves in the radial direction on the disk medium 2 by a driving force of a voice coil motor.

The control and signal processing system comprises a microprocessor (CPU) 60 mounted on a printed circuit board 6, or various types of circuit components. The CPU 60 records data for examination from the examination unit 10 in the disk medium 2 by means of the head 4, and produces the data for examination read from the disk medium 2 by the head 4 to output the data to the examination unit 10.

Moreover, as a component included in the drive mechanism, a stopper member 7 is disposed in such a manner that the actuator 5 is stopped in a predetermined position on an innermost peripheral side of the disk medium 2.

### Servo Information Writing Step

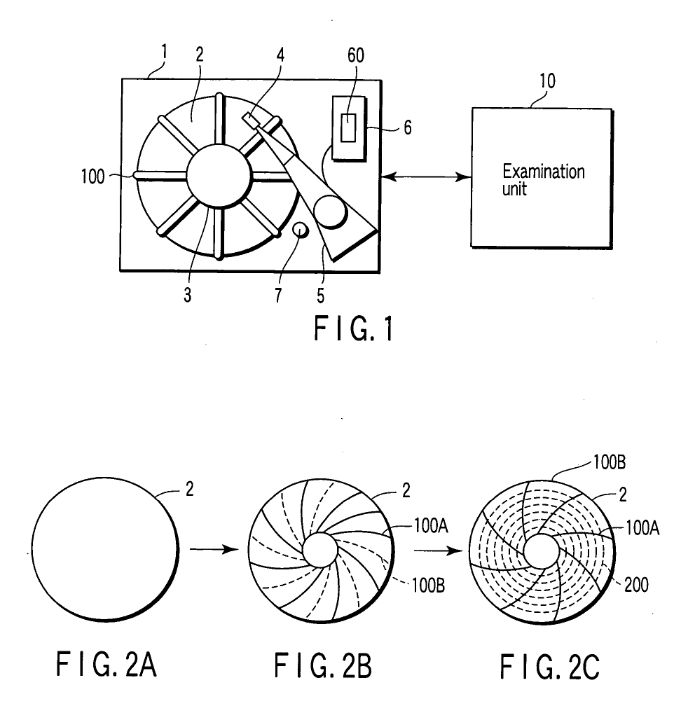

A servo information writing step will be described hereinafter according to the present embodiment with reference to FIGS. 2A to 2C.

In the servo information writing step of the present embodiment, a magnetic transfer unit writes two or more types of servo patterns 100A, 100B to the disk medium 2 shown in FIG. 2A, called a blank medium, and having an unrecorded state by means of a magnetic transfer method.

Here, as shown in FIG. 2B, two types of servo patterns 100A, 100B are recorded which have different track pitches. The track pitch corresponds to a track interval between tracks constituted based on the servo patterns. These servo patterns 100A, 100B include ID information for the disk drive 1 and the examination unit 10 to identify the patterns, respectively. The servo pattern 100A is the same as the servo pattern 100B in a sector number and servo data (mainly a track address code and servo burst data).

Here, the magnetic transfer method is a method in which a master disk for transfer is prepared, and the same servo patterns (here two or more types of servo patterns) are transferred and recorded with respect to the respective disk mediums 2 incorporated in the disk drive 1.

In the servo information writing step, as shown in FIG. 2C, for example, the servo pattern 100A is selected based on the result of examination processing as described later, and set as servo information of the disk drive 1 to be shipped as the product. In the disk drive 1, a data track 200 is constituted on the disk medium 2 based on, for example, the set servo pattern 100A.

### Procedure of Servo Information Write Processing

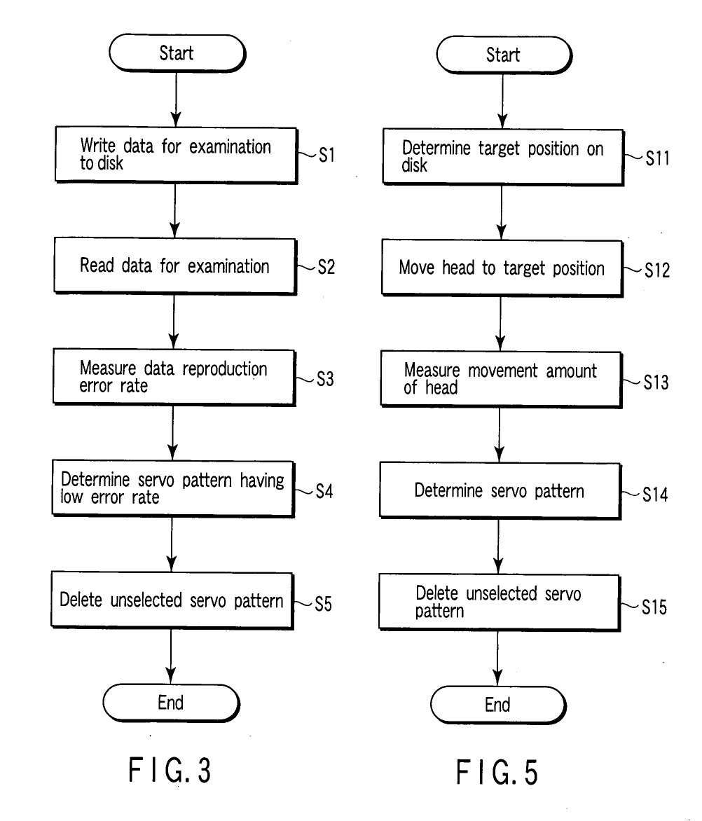

Next, a procedure of servo information write processing will be described according to the present embodiment with reference to a flowchart of FIG. 3.

As described above, two types of servo patterns 100A, 100B having different track pitches are recorded in the disk medium 2 incorporated in the disk drive 1. In the disk drive 1, as to the head 4, a write head element which performs a data write operation (recording) is mounted separately from a read head element which performs a data read operation (reproducing).

The data track constituted on the disk medium 2 has a track width corresponding to an element width of the write head element. The write head element is positioned in a target position to execute a write operation based on the servo pattern reproduced by the read head element. Therefore, the write head element is positioned in accordance with the track pitch determined based on the servo pattern.

Here, there is a possibility that the element width of the write head element is formed to be broad with respect to the track pitch in steps of manufacturing the head 4. In this case, there is a possibility that data is overwritten in a track adjacent to the track to delete a part of the recorded data at a time of the data write operation by the write head element. Similarly, when the element width of the read head element is broader than that set using the track pitch as a reference, there is a possibility that the recorded data is read from the adjacent track at a time of reproduction of the data,

Therefore, the track pitch set based on the servo pattern, that is, the track width has an optimum value which differs depending on the element width of each of the write head element and the read head element of the head 4.

Next, a procedure of servo information write processing will be specifically described according to the present embodiment.

The examination unit 10 writes data for examination (a type of user data) to the disk medium 2 of the disk drive 1 by means of the write head element of the head 4 (step S1). In this case, actually, the CPU 60 incorporated in the disk drive 1 controls the actuator to position the head 4 (here the write head element) based on the servo pattern 100A or 100B reproduced from the disk medium 2 by the read head element in accordance with an instruction from the examination unit 10. The servo pattern (100A or 100B) for use in positioning the head 4 is identified by ID information included in each pattern as described above.

Next, the examination unit 10 positions the read head element to read and reproduce the data for examination as recording data from the disk medium 2 via the CPU 60 (step S2). The examination unit 10 executes the recording of the data for examination by the write head element and the reproducing of the data for examination by the read head element by use of the servo patterns 100A, 100B, respectively. Moreover, the examination unit 10 measures a data reproduction error rate of the data for examination for each of the servo patterns 100A, 100B (step S3).

The examination unit 10 selects the servo pattern 100A or 100B having a relatively low reproduction error rate based on the measured data reproduction error rate to determine the pattern as the servo information to be actually used in the disk drive 1 (step S4).

Here, in a case where the servo pattern having an excessively narrow track pitch (track width) is selected with respect to the element width of the write head element or the read head element of the head 4 incorporated in the disk drive 1 in the servo patterns 100A, 100B having different track pitches, it is presumed that the data reproduction error rate increases owing to interference with the adjacent track. Therefore, the examination unit 10 selects the servo pattern (e.g., servo pattern 100A) having a relatively low data reproduction error rate.

Furthermore, the examination unit 10 executes processing to delete an unselected servo pattern (e.g., the pattern 100B) on the disk medium 2 via the CPU 60 of the disk drive 1 (step S5).

It is to be noted that the processing to delete the servo pattern by the examination unit 10 is not necessarily required. That is, in the disk drive 1, the CPU 60 records the user data in the disk medium 2 by use of the selected and set servo pattern (100A) as the servo information to thereby overwrite the data on the unselected servo pattern (100B). Therefore, the unselected servo pattern (100B) is deleted from the disk medium 2 as a result. Additionally, since the user data is not recorded on the innermost peripheral side of the disk medium 2, the unselected servo pattern (100B) recorded in this place remains without being deleted.

It is to be noted that the CPU 60 incorporated in the disk drive 1 may select and set the servo pattern (100A) in accordance with the examination result of the examination unit 10.

According to the present embodiment, the adequate servo pattern is selected from the plurality of types of servo patterns. Accordingly, an optimum servo pattern in which the track pitch related to properties of the head, eccentricity related to the assembly precision of the disk medium, or the like is considered can be set as the servo information on the disk medium.

### Modification

In the present embodiment, as the method of selecting the servo pattern, the examination unit 10 selects the adequate servo pattern based on a relation between each element width and a recording/reproducing property of the head 4. As a modification of the embodiment, in the method, a servo pattern of an adapted track pitch may be selected based on predetermined specifications (especially, each element width of a head 4) of a disk drive 1. In this case, specifically, an examination unit 10 prepares examination data of components for use in accordance with the specifications of the disk drive 1, and selects the servo pattern of the adapted track pitch based on the examination data.

### Another Embodiment

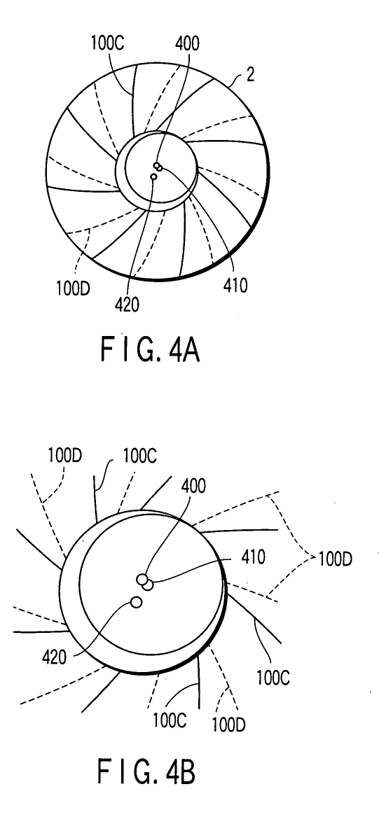

FIGS. 4A, 4B, and 5 are diagrams according to another embodiment.

In the present embodiment, as shown in FIG. 4A, servo patterns 100C, 100D having different central positions (hereinafter referred to as the eccentric positions) of track circles are recorded as a plurality of types servo patterns on a disk medium 2 by, for example, a magnetic transfer method. It is to be noted that the respective servo patterns 100C, 100D have an equal track pitch (track interval), an equal sector number, and the same servo data constitution.

In a step of assembling a disk drive 1, in a case where the disk medium 2 in which the servo patterns are recorded is incorporated, an assembly tolerance (hereinafter referred to as eccentricity) is generated. In a case where data is recorded and reproduced with respect to the disk medium 2 in which the eccentricity has been generated, a head 4 needs to be adjusted in such a manner as to be moved depending on the eccentricity. Therefore, when the eccentricity is large, a movement amount of the head 4 relatively increases. As a result, power consumption of the disk drive 1 is increased.

FIG. 4B (enlarged diagram of a central portion of FIG. 4A) shows a rotation center 400 of the disk medium 2, and different eccentric positions 410, 420 of two types of servo patterns 100C, 100D. The eccentric position 410 corresponds to a central position of the servo pattern 100C. The eccentric position 420 corresponds to the central position of the servo pattern 100D.

Next, a procedure of servo information write processing of the present embodiment will be specifically described.

An examination unit 10 determines a target position for examination to which the head 4 is to be moved in the disk medium 2 (step S11). Next, the examination unit 10 moves the head 4 to the target position for examination to position the head by means of a head positioning control system incorporated in the disk drive 1 (step S12). In this case, the examination unit 10 identifies the servo patterns 100C, 100D for use in positioning the head 4 by ID information included in each pattern, and executes a head positioning control (movement control) by use of the servo patterns 100C, 100D, respectively.

Next, the examination unit 10 measures a movement amount of the head 4 until the head is positioned in the target position for examination, when executing the head positioning control by use of the servo patterns 100C, 100D, respectively (step S13). The examination unit 10 selects the servo pattern 100C or 100D having a relatively less movement amount based on the measured movement amount of the head 4, and determines the pattern as servo information to be actually used in the disk drive 1 (step S14).

That is, in a case where the movement amount of the head 4 is relatively small, it can be judged that the eccentricity of the selected servo pattern 100C or 100D is small. Here, as to the measurement of the movement amount of the head 4, the examination unit 10 measures a maximum value of a current actually consumed at a head moving time. In brief, the examination unit 10 selects the servo pattern in which the power consumption of the disk drive 1 accompanying the movement of the head 4 is minimized.

Furthermore, the examination unit 10 deletes an unselected servo pattern on the disk medium 2 via a control system of the disk drive 1 (step S15). It is to be noted that the delete processing of the servo pattern by the examination unit 10 is not necessarily required in the same manner as in the above-described embodiment. That is, in the disk drive 1, when the user data is recorded on the disk medium 2 by use of the selected and set servo pattern having a less eccentricity as the servo information, the data is overwritten on the unselected servo pattern. Therefore, the unselected servo pattern is deleted from the disk medium 2 as a result. Additionally, since the user data is not recorded on an innermost peripheral side of the disk medium 2, the unselected servo pattern recorded in this place remains without being deleted.

### Modification

The present embodiment relates to a writing method in which the movement amount (power consumption) is measured accompanying the positioning control (movement control) of the head 4 by use of the respective servo patterns 100C and 100D, and the servo pattern 100C or 100D having a comparatively less movement amount (less power consumption) is selected based on the measurement result.

As a modification of the embodiment, as shown in FIG. 4B, a servo pattern 100C may be selected which has an eccentric position 410 relatively close to a rotation center 400 of a disk medium 2. Since this servo pattern 100C has a small eccentricity, it is possible to minimize a movement amount of a head 4 at a data recording or reproducing time.

Moreover, an examination unit 10 may measure the eccentricities of the respective servo patterns 100C and 100D, and select the servo pattern having a minimum eccentricity. In this case, in a state in which an actuator 5 is pressed onto a stopper member 7 corresponding to an innermost peripheral position of the disk medium 2, the examination unit 10 reproduces the respective servo patterns 100C and 100D to thereby measure the eccentricity.

As described above, according to the servo information writing method of each embodiment, the disk medium 2 in which a plurality of types of servo patterns are recorded is incorporated in the disk drive 1, and the adequate servo pattern is selected and set as the servo information to be actually used based on selection conditions such as the recording/reproducing property (data reproduction error rate) and the movement amount of the head 4. Therefore, as a result, the optimum servo pattern in which the track pitch related to the properties of the head 4, the eccentricity related to the assembly precision of the disk medium 2 and the like are considered can be recorded as the servo information on the disk medium 2.

It is to be noted that as to a shipping examination value of the head 4, the servo pattern optimum for the head property is selected in a case where fluctuations of the properties exist between the heads which face the disk surface. Therefore, there is a case where the servo pattern selected with respect to the surface of one disk medium 2 is different from that selected with respect to the back surface.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An apparatus for servo writing in a disk drive, comprising:
an examination unit which executes examination to select an adequate servo pattern from a plurality of types of servo patterns recorded on a disk medium incorporated in the disk drive; and
a selection unit which selects as servo information of the disk drive the servo pattern judged to be adequate by the examination unit.

2. The apparatus according to claim 1, wherein the examination unit positions a head incorporated in the disk drive in a target position based on the plurality of types of servo patterns recorded on the disk medium via a control and signal processing system incorporated in the disk drive,
records data for examination on the disk medium by use of the head,
reproduces the data for examination by use of the head, and
measures a reproduction error rate of the reproduced data for examination, and
the selection unit selects the servo pattern having a relatively low reproduction error rate measured by the examination unit as the servo information of the disk drive.

3. The apparatus according to claim 1, wherein the examination unit positions a head incorporated in the disk drive in a target position based on the plurality of types of servo patterns recorded on the disk medium via a control and signal processing system incorporated in the disk drive, and
measures a movement amount of the head to the target position, and
the selection unit selects the servo pattern having a relatively small movement amount of the head measured by the examination unit as the servo information of the disk drive.

4. The apparatus according to claim 1, wherein the plurality of types of servo patterns are two or more types of servo patterns having different track pitches.

5. The apparatus according to claim 1, wherein the plurality of types of servo patterns are two or more types of servo patterns having different eccentricities.

6. The apparatus according to claim 1, wherein the selection unit deletes from the disk medium the servo pattern judged to be unselected based on a judgment result of the examination unit.

7. The apparatus according to claim 1, wherein a control and signal processing system incorporated in the disk drive deletes from the disk medium the servo pattern judged to be unselected based on a judgment result of the examination unit.

8. A method of servo writing for a disk drive, the method comprising:
executing examination to select an adequate servo pattern from a plurality of types of servo patterns recorded on a disk medium incorporated in the disk drive; and
selecting as servo information the servo pattern judged to be adequate by the execution of the examination.

9. The method according to claim 8, wherein the execution of the examination positions a head incorporated in the disk drive in a target position based on the plurality of types of servo patterns recorded on the disk medium,
records data for examination on the disk medium by use of the head,
reproduces the data for examination by use of the head, and
measures a reproduction error rate of the reproduced data for examination, and
the selection selects the servo pattern having a relatively low reproduction error rate measured by the examination as the servo information of the disk drive.

10. The method according to claim 8, wherein the execution of the examination positions a head incorporated in the disk drive in a target position based on the plurality of types of servo patterns recorded on the disk medium, and
measures a movement amount of the head to the target position, and
the selection selects the servo pattern having a relatively small movement amount of the head measured by the examination as the servo information of the disk drive.

11. The method according to claim 8, wherein the selection deletes from the disk medium the servo pattern judged to be unselected based on a judgment result of the examination.

12. The method according to claim 8, wherein the plurality of types of servo patterns recorded on the disk medium are two or more types of servo patterns having different track pitches.

13. The method according to claim 8, wherein the plurality of types of servo patterns recorded on the disk medium are two or more types of servo patterns having different eccentricities.
